(19) United States
(12) Patent Application Publication
(10) Pub. No.: US 2004/0020109 A1
(43) Pub. Date: Feb. 5, 2004

(54) Permanent, modular, porous, engineered turf grass reservoir, weed preventative and insect preventative method and apparatus

(76) Inventor: Joe Don Byles, New Braunfels, TX (US)

Correspondence Address: Joe D. Byles, 20 Timber Meadow, New Braunfels, TX, 78132, US

(21) Appl. No.: 10/628,530

(22) Filed: Jul. 28, 2003

Related U.S. Application Data
(60) Provisional application No. 60/399,329, filed on Jul. 29, 2002.

(51) Int. Cl. A01G 9/00

(52) U.S. Cl. 47/1.01 F

(57) ABSTRACT

A turfgrass or landscape planting moisture and air reservoir, base soil weed germination preventor, and insect soil movement preventor employing a substantially continous dimensional reticulated panel on the soil surface which turf grass or ornamental landscape plantings are placed or produced, the panel allowing the turf grass and ornamental landscape planting roots to go downward through it but not allowing the leaf or stem area of weeds sprouting from the base soil to move up through it and also not allowing insects to move up or down through it and holding air and water within its area for the turf grass or ornamental plant roots growing through the pane material.

### CROSS REFERENCE TO RELATED APPLICATION

This application claims the benefit of prior provisional application Ser. No. 60/399,329 filed Jul. 29, 2002, entitled PERMENANT MODULAR, POROUS, ENGINEERED TURF GRASS RESERVOIR, WEED PREVENTATIVE AND INSECT PREVENTATIVE METHOD AND APPARATUS.

### BACKGROUND OF THE INVENTION

This invention relates to means and methods of preventing noxious weeds and pest insect infestations into turf grass and landscape planter bed areas through the use of permanent, non-chemical, mechanical means.

The care of lawns in the United States of America and abroad has become a large, chemically driven business as home and business owners look to provide a pristine, weed and pest insect free environment around homes, businesses and anyplace where landscaping is present. The general elimination of unwanted entities in a lawn environment can be broken into two basic groups: unwanted weeds and unwanted insects.

The first category of unwanted weeds and plants in a monoculture lawn is usually dealt with on a chemical level. There are literally hundreds of chemical compounds, systemic and non-systemic, developed to prevent weed growth with a lawn environment. Common state of the art chemical treatments range from broadcasting granular herbicides to spraying herbicides from a hose end aspirator to hiring a professional company to apply a specific mix of herbicides depending upon the mix of noxious weeds present. The major negative of this type of care to rid weeds from a lawn environment are that all herbicides, once placed on the soil and plant material, tend to break down over time and the chemical must be re-applied. Another major negative to this is that herbicides are toxic and can affect certain plants, animals and people in unintended ways if not properly applied and even sometimes when properly applied. Still another drawback with herbicides is that when applied by homeowners, the proper amount and location might not be applied, damaging the environments. Chemicals applied to the lawn are also subject to translocation due to rain and irrigation water, moving the chemicals into public water supplies, rivers, lakes and streams. Altogether, chemical applications on lawns to prevent or remove noxious weeds has the above mentioned drawbacks but still is the preferred method of weed control as a more effective and safer method has not to date been developed.

Attempts to control insects in a turf grass lawn have similar chemical means to that described for controlling noxious weeds. The most common defense for lawn insect pests, such as grubworms, molecrickets, fire ants, etc. is often centered around a chemical that is toxic to the specific pest. Chemicals developed to kill and destroy insect pests in lawns are, like weed killing chemicals, very plentiful. While the chemicals will kill the insect pests, they suffer from the same basic drawbacks that the chemical week killers suffer from. First, they are a chemical that can break down and therefore must be re-applied to consistently keep the insect infestation to a minimum. Also, being a chemical, it is subject to entry into the drinking water sources and waterways. Homeowners also can misapply and over-apply the chemical leading to unintended and dangerous results. Again, chemical applications on lawns to prevent insect infestation has the above mentioned drawbacks but still is the preferred method of insect control as more effective and safe methods have not been introduced.

All in all, no one prior art method or product for controlling unwanted weeds and insects in a lawn environment has been developed which doesn't rely on heavy chemical usage and constant re-application of the chemicals.

### SUMMARY OF THE INVENTION

It is therefore a general objective of the current invention to overcome the above-described limitations and recurring labor and chemical requirements associated with prior art methodologies for eliminating weeds and insects form lawns.

In order to accomplish the objectives of the current invention, the system apparatus according to the invention includes in one preferred embodiment a panel of material consisting of a non-reticulated, partially reticulated or fully reticulated expanded polyether polyurethane foam material of sufficient thickness to be placed beneath a uniform planting of lawn materials. Additional laminations or layers can be added in other embodiments of the invention to provide resistance to damage from shovels, etc.

Additional laminations can include wire meshes, spun bound polyurethane fiberous materials, or any material which will lend tensile strength and tear resistance to the base polyether polyurethane without affecting the intended porosity and open-closed cell structure ration. However, it should be noted that the material can be cut with a shovel or lawn tool and still not loose its effectiveness as described in subsequent theory of operation section of this application

The permanent, modular, porous, engineered turf grass reservoir, weed preventative and insect preventative method and apparatus is installed by placing the panels of materials, in whatever size and configuration that it is produced and manufactured in, directly on top of the final graded, intended lawn area, and then placing the sod turf grass on top of the panels. The panel materials can be placed directly on top of an uncultivated soil and even on top of a fully growing group of weeds and weed seed infested soils. The panels can be cut to follow the final intended shape of the lawn turf area or flower bed area that the turf grass sod will be laid in.

In another form of installation of the system, the panels can be laid out in the shape of the lawn and a layer of soil placed on top of the panels. A turf grass seed can then be broadcast onto the soil and irrigated to so that a lawn will grow where the grass seed is planted.

It should be noted that in both of the above described applications the panels should be installed such that the entire area that is to have a lawn is covered by the panel material and that at the joints of the panels the panels butt up into direct contact with each other or overlap.

### THEORY OF OPERATION

The permanent, modular, porous, engineered turf grass reservoir, weed preventative and insect preventative method and apparatus operates to provide several beneficial functions to the turf grass under which it is installed.

The first benefit is the restriction of growth of weeds which are present and growing beneath the panel material. The polyether polyurethane material has a partially open cell structure such that it allows air and water to freely move from the sod area of the turf grass to the lower base soil. The open cell structure is sized such that the roots of the turf grass plants move freely into the panel, through it and out the bottom into the base soil materials where they can access water and nutrients. However, because a weed or weed plant germinating from a seed beneath the panel has leaf and stem material that is much larger than the roots of the turf grass plants, the weed is prevented from emerging and dies beneath the soil. This action of only allowing the turf grass roots down through the panel and no weed or other plant material up from the base soil through the panel prevents weeds inherent in the base soil from entering the turf grass area. The only weeds which will be present in the lawn will be those which are brought in by external sources such as birds, people, etc. These weeds, however, tend to be very limited in nature compared to the weeds which come from base soils.

The second benefit is the restriction of habitat suitable for insect pests that live in turf grass lawn areas. The panel layer directly below the turf grass presents a continuous, structured material, unlike soil, which can be burrowed through or moved easily. Pest insects which live below lawns, such as grub worms, mole crickets, ants, and fire ants cannot have access below the panel material or access above the panel material. The structural characteristics of the panel material is such that ants, insects and grubs cannot navigate through the material as its cells are too small, too convoluted and too strong. In both cases, the restriction of soil habitat makes the environment uninviting for the pest insects and it has been observed in installations that they move on to a more suitable environment or die.

Several other benefits of the panel material, which lead to a stronger stand of turf grass growth, lead also to a less likely scenario of insect or pest weed infestation. It is commonly observed that a strong healthy lawn will be pest insect and weed free because of the dense, vigorous growth of grass plants. To the end of vigorous growth, the panel material provides a perfect reservoir beneath the turf grass that holds air and water from irrigation or rain events. The material, even in a relatively thin layer of one fourth of an inch can hold as much water as up to 6 inches of soil. Also, the structure of the panel is such that even in an environment of totally saturated soil, there is air present in the panel, providing a necessary element to healthy grass growth. Also, because there is constantly air present and the roots growing through the panel there is no need to core areate the turf area to relieve compaction which can normally be present in a turf grass area. The panels act as a form of permanent aeration and compaction prevention, promoting healthy grass which further withstands weed and insect invasion in addition to the above described physical prevention methods.

The permanent, modular, porous, engineered turf grass reservoir, weed preventative and insect preventative method and apparatus offers the following benefits or convention prior art chemical methods of weed and insect control as listed below:

1. Once the panel is installed, weeds are prevented from growing from the base soil where they can remain dormant for years and years for as long as the panel is present beneath the turf, without the use of chemicals.

2. Once the panel is installed, the unsuitable habitat is maintained for as long as the panel is present beneath the turf grass with out any need for additional materials and no chemical treatments.

3. Once the panel is installed, a optimum rooting and growth medium for the turf grass plants is established which promotes healthy grass by providing a moisture and oxygen reservoir for the turf grass roots growing through the panel material.

4. The benefits are accomplished without the use of chemicals.

5. There is no need for recurring chemical applications.

6. Water contamination for chemicals are reduced.

The above listed benefits and features, considered with the panel descriptions from above will become more evident when considered with the following drawings and descriptions.

### BRIEF DESCRIPTION OF THE DRAWINGS

FIG. 1 shows the panel material installed over a base soil with turf grass growing through it.

### DESCRIPTION OF THE PREFERRED EMBODIMENTS

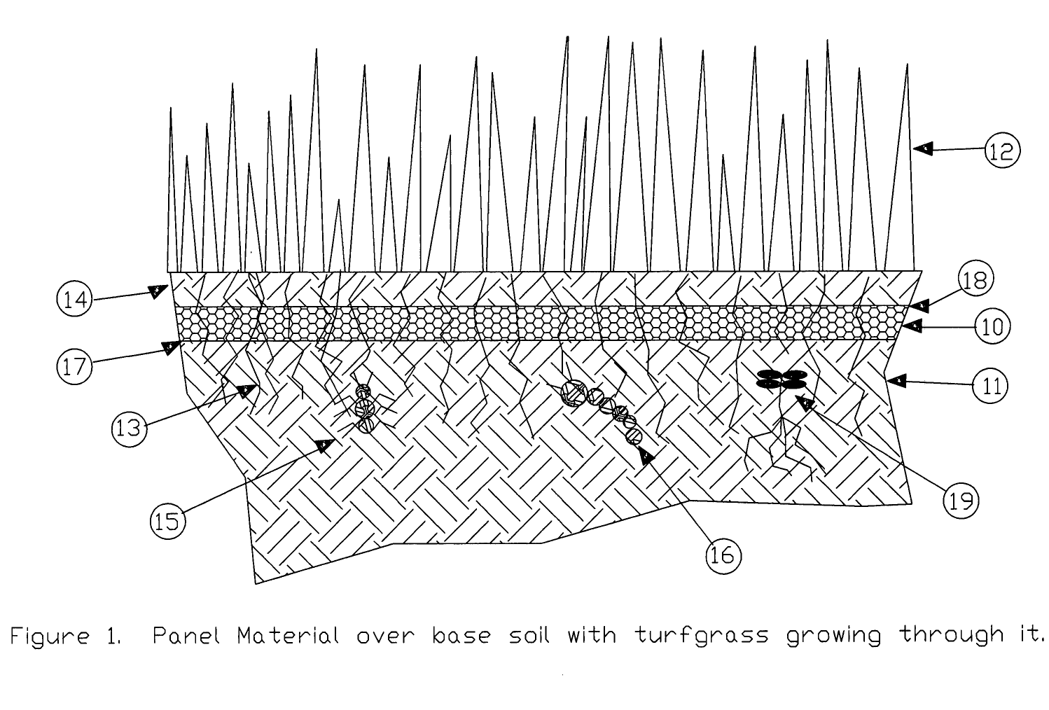

FIG. 1 shows the panel material 10 installed over a base soil 11 with turf grass 12 growing through it. The roots 13 of the turf grass 12 completely penetrate the panel material 10 and grow into the base soil 11. There is only a small amount of soil 14 above the panel material 10 which was associated with the turf grass 12 sod. The soil 14 could also be placed there from a turf grass seed establishment. Any insects such as ants 15, grubworms and mole ckrickets 16, cannot penetrate the panel material 10, base soil 11 interface 17. Any insects on the surface of the turf also cannot penetrate the turf grass sod soil 14, panel material 10 interface 18. Any weed 19 germinated in the base soil 11 cannot penetrate the panel material 10, base soil 11 interface 17 and therefore grow into a weed that lives within the lawn. The roots 13 grow through the panel material 10 which because of its cellular structure provides an air and water reservoir to the grass roots 13. Any additional layers laminated to the panel material 10 can be done above, within or below the panel to provide protection from tools and animals.

The above described preferred embodiments are intended to illustrate the principles of the invention, but not to limit the scope of the invention. Various other embodiments and modifications to these embodiments may be made by those skilled in the art without departing from the scope of the invention as described.

What is claimed is:

1. A method of installing a turfgrass or landscape planting moisture and air reservoir, base soil weed germination preventor, and insect soil movement preventor, the method comprising the steps of:
positioning a substantially continous dimensional reticulated material over a base surface in an area which is to contain landscape plantings; and positioning turfgrass or landscape plants over the substantially continous panel, wherein the dimensional reticulated material consists of a material with a partially open cell size such that roots of turfgrass and landscape plants growing from above the material can penetrate and grow through the material but leaf material of weeds and plant seeds germinating from below the material are too large and cannot grow up through the cell size of the material, also wherein the cell size of the reticulated material is too small for insects to enter and move through the material, also wherein the reticulated material provides an air and water reservoir for the roots growing into the reticulated material.

2. The method of claim 1 wherein the substantially continous dimensional reticulated material is chosen from a material of polyurethane foams.

3. The method of clam 2 wherein the polyurethane foam is made up of a polyether material that is non-reticulated and has an open cellular structure.

4. The method of claim 2 wherein the polyurethane foam has a pore size of substantially 100 pores per inch.

5. The method of claim 2 wherein the polyurethane foam has a density of 0.1 to 20 pounds per cubic foot.

6. The method of claim 1 wherein the open cell reticulated material is laid down in panels which substantially butt up to each other or over lap so as to leave no gaps beneath the turfgrass or landscape plantings.

7. A method of installing a turfgrass or landscape planting moisture and air reservoir, base soil weed germination preventor, and insect soil movement preventor, the method comprising the steps of:
positioning a substantially continous dimensional reticulated material over a base surface in an area which is to contain landscape plantings; and positioning turfgrass or landscape plants over the substantially continous panel, wherein the dimensional reticulated material consists of a material with a partially open cell size such that roots of turfgrass and landscape plants growing from above the material can penetrate and grow through the material but leaf material of weeds and plant seeds germinating from below the material are too large and cannot grow up through the cell size of the material, also wherein the cell size of the reticulated material is too small for insects to enter and move through the material, also wherein the reticulated material provides an air and water reservoir for the roots growing into the reticulated material.; and periodically injecting a gaseous or liquid pest control material into the open, cellular structure of the reticulated material.

8. The method of claim 7 wherein the gaseous or liquid pest control material is injected into the open, cellular structure of the reticulated material by a sharp needle-like device which penetrates the top turfgrass or landscape planting area into the open cell reticulated material where an orifice in the needle directly injects the material under pressure.

9. A weed and insect control apparatus adapted to be incorporated into the root zone of a turfgrass or landscape planting area, the apparatus comprising:
a substantially continous dimensional reticulated panel material which may be positioned substantially parallel to the area to be planted; the dimensional reticulated material consisting of a material with a partially open cell size such that roots of turfgrass and landscape plants growing from above the material can penetrate and grow through the material but leaf material of weeds and plant seeds germinating from below the material are too large and cannot grow up through the cell size of the material, also wherein the cell size of the reticulated material is too small for insects to enter and move through the material, also wherein the reticulated material provides an air and water reservoir for the roots growing into the reticulated material.

10. The apparatus of claim 9 wherein the substantially continous dimensional reticulated material is chosen from a material of polyurethane foams.

11. The apparatus of clam 10 wherein the polyurethane foam is made up of a polyether material that is non-reticulated and has an open cellular structure.

12. The apparatus of claim 11 wherein the polyurethane foam has a pore size of substantially 100 pores per inch.

13. The apparatus of claim 10 wherein the polyurethane foam has a density of 0.1 to 20 pounds per cubic foot.

14. The apparatus of claim 9 wherein the open cell reticulated material is laid down in panels which substantially butt up to each other or over lap so as to leave no gaps beneath the turfgrass or landscape plantings.

15. A weed and insect control apparatus adapted to be incorporated into the root zone of a turfgrass or landscape planting area, the apparatus comprising:
a substantially continous dimensional reticulated panel material which may be positioned substantially parallel to the area to be planted; the dimensional reticulated material consisting of a material with a partially open cell size such that roots of turfgrass and landscape plants growing from above the material can penetrate and grow through the material but leaf material of weeds and plant seeds germinating from below the material are too large and cannot grow up through the cell size of the material, also wherein the cell size of the reticulated material is too small for insects to enter and move through the material, also wherein the reticulated material provides an air and water reservoir for the roots growing into the reticulated material; and
a means for injecting a gaseous or liquid pest control material into the open, cellular structure of the reticulated material.

16. The apparatus of claim 15 wherein the gaseous or liquid pest control material is injected into the open, cellular structure of the reticulated material by a sharp needle-like device which penetrates the top turfgrass or landscape planting area into the open cell reticulated material where an orifice in the needle directly injects the material under pressure.
